(19) United States
(12) Patent Application Publication
(10) Pub. No.: US 2014/0281928 A1
(43) Pub. Date: Sep. 18, 2014

(54) CONTENT-DRIVEN LAYOUT

(71) Applicants: Vladimir Tkach, Netania (IL); Ev Shafrir, Kfar Vitkin (IL); Nati Ari, Zoran (IL)

(72) Inventors: Vladimir Tkach, Netania (IL); Ev Shafrir, Kfar Vitkin (IL); Nati Ari, Zoran (IL)

(73) Assignee: SAP Portals Israel LTd., Ra'anana (IL)

(21) Appl. No.: 13/796,108

(22) Filed: Mar. 12, 2013

(51) Int. Cl. G06F 17/21

(52) U.S. Cl. CPC G06F 17/212
USPC 715/243

(57) ABSTRACT

The disclosure generally describes computer-implemented methods, software, and systems for generating content-driven layouts. One method includes: receiving a first user input specifying a template rule for a template being generated, receiving a second user input specifying a template part rule for a part of the template, wherein the template part rule takes precedence over the template rule, and receiving a third user input specifying a container rule for a container located in the part of the template, wherein the container rule takes precedence over the template part rule and the template rule. Based on content provided for the template, at least one of the template rule, template part rule and the container rule is applied based on the precedence, and the template is presented.

### BACKGROUND

In the past, some hard-coded unlimited surfaces have been used. In one of them, the user sees a bar at the edge of the current viewport: clicking the bar navigates the user further along the unlimited surface in that direction. Hovering over an element can change its appearance. The user need not move elsewhere in the surface in order to navigate to some particular content.

### SUMMARY

The disclosure generally describes computer-implemented methods, software, and systems for generating content-driven layouts. One method includes: receiving a first user input specifying a template rule for a template being generated, receiving a second user input specifying a template part rule for a part of the template, wherein the template part rule takes precedence over the template rule, and receiving a third user input specifying a container rule for a container located in the part of the template, wherein the container rule takes precedence over the template part rule and the template rule. Based on content provided for the template, at least one of the template rule, template part rule and the container rule is applied based on the precedence, and the template is presented.

The details of one or more implementations are set forth in the accompanying drawings and the description below. Other features and advantages will be apparent from the description and drawings, and from the claims.

### DESCRIPTION OF DRAWINGS

FIG. 1 shows an example of a layout surface.

FIG. 2 shows another example of a layout surface.

FIG. 3 shows an example of a layout surface with diagonal content bands.

FIG. 4 shows an example of a layout surface with concentrically circular content bands.

FIG. 5 shows an example of a layout surface with a control element.

FIG. 6 shows an example of a tool for generating a layout and/or a template.

FIG. 7 shows an example of the tool from FIG. 6.

FIG. 8 shows an example of the tool from FIG. 6.

FIG. 9 shows an example of the tool from FIG. 6.

FIG. 10 shows an example of the tool from FIG. 6.

FIG. 11 shows an example of the tool from FIG. 6.

FIG. 12 shows an example of the tool from FIG. 6.

FIG. 13 shows an example of the tool from FIG. 6.

FIG. 14 shows an example of the tool from FIG. 6.

FIG. 15 shows an example of the tool from FIG. 6.

FIG. 16 shows an example of the tool from FIG. 6.

FIG. 17 shows an example of the tool from FIG. 6.

FIG. 18 shows an example of the tool from FIG. 6.

FIG. 19 shows an example of the tool from FIG. 6.

FIG. 20 is a block diagram of a computing system that can be used in connection with computer-implemented methods described in this document.

FIGS. 21-26 illustrate operations and options of example rules on widgets, containers, and templates.

Like reference symbols in the various drawings indicate like elements.

### DETAILED DESCRIPTION

This document describes systems and techniques for content-driven layout. The source(s) of content and/or the content item(s) decide how a layout surface is created and organized. In some implementations, each content type can determine the container widget most appropriate for that item or item stream. For example, a stream of news items can request to be presented in a vertical column with an optimal width range (e.g., a minimum and/or maximum), with one photo of specific size, minimal article text length, with ranking, automatically created links for access to the full content, and other interactions. As another example, a sports news item can request to be presented in a box style layout with a larger picture and one or more media links. In a mobile device, the same news item(s) can request alternative display and/or layout policies. For example, content can predefine the size of a container and/or the shape of the container (e.g., vertical, horizontal, circular, etc.) As another example, content can predefine a temporal presentation and/or interaction (e.g., when or how long to present, whether to make viewable or interactive, etc.)

In some implementations, the present subject matter provides a system that generalizes the creation of layouts and designs of endless surfaces. For example, from an arbitrary number of content inputs a mat can be created. A general engine is used to transform rules into different layouts. The rules can define when the content is available, and how it is explored. For example, the engine can specify that the content is to be broken into two or more columns, and how the content should behave upon scrolling or flipping, to name just a few examples. In a layout generated using such an engine, there may be no need to hide information in multiple hierarchy levels.

In some implementations, a layout-generating engine generates rules across the board for any kind of content. For example, the rule can state that content may be 100 pixels wide. But if the content is more than 300 pixels wide, the rule causes the content to be scaled down. When the content is between these widths, it may be fine under the rule. As another example, a comment that is part of a content item can run for a relatively long time. The rule can specify a way of dealing with the length (such as by capping the display of the comment at 250 characters.)

That is, the engine can specify, for every type of content, a rule for “less” of that content, a rule for “more,” and how the user is taken to explore more of the content. For example, the rule can specify when to expand the content, grow the page, or make the page wider. The engine does so without resorting to a hierarchical organization that uses a supersurface or a box above the content, but rather by changing how the page behaves according to the amount of content that is on the page.

As a particular example, a layout for items of a social network (e.g., a site for sharing content) can be generated. The rule(s) can specify that an item with a social interest (e.g., as manifested by the number of positive user-responses) of less than 400 is not to be presented. If the interest exceeds 400, the item is displayed on the page. If the interest exceeds 1000, the item is placed in the left side column. If the interest is more than 5000, the item is provided with a graphic embellishment and placed at the top of the page. That is, the rule(s) can specify whether, where and how to show content based on the social interaction or interest associated with the content.

In the following, examples are described that illustrate possible operations of a layout-generating engine.

FIG. 1 shows an example of a layout surface 100. This example and the following one demonstrate that a layout surface can grow in any direction and is not confined by, say, a rectangular boundary. For example, no hierarchy has been defined with content. Rather, some surface areas can display a collection—or infinite streams—of content items. For example, the layout surface 100 here conceptually indicates this using stacks 102 of content items. These collections (or streams) can be displayed one item at a time based on one or more display rules.

FIG. 2 shows another example of a layout surface 200. The layout surface is accessed using a viewport 202, here conceptually illustrated as a tablet or other handheld electronic device. The viewport 202 can be relocated anywhere on the layout surface, as indicated by a navigation symbol 204. However, no scrollbars or scrolling may be necessary although the layout surface may be an “endless” layout surface that is bigger than any viewport (e.g., than the viewport 202). In some implementations, interactive content in the layout surface when accessed can cause other content to come into the area of the viewport. For example, this can be done by a smooth display-update transition.

Also, a periphery line 206 schematically illustrates that borders are not required for display and management of the layout surface 200. In some implementations, this can be considered a borderless layout. For example, this visual technique can enable integrated content display and use of established graphic design patters from print or interactive media.

Some implementations provide a responsive design and unlimited-size surfaces. For example, the endless surface can be smart and (among other things) rearrange the layout modules to the viewport and rearrange the display of content element in each layout component. This can provide for display of an endless surface within viewports of differing widths and heights, and accommodate wide and tall viewing preferences (e.g., landscape, portrait) and non-rectangular viewports (e.g., honeycomb).

In some implementations, to respond to changes in screen dimension the endless surface can apply responsive design rules such that, say, a newspaper layout will look best through each device viewport. For example, and without limitation, such responsive strategies can include: Widening or narrowing information columns, changing a visible item count in each column and/or each module, or changing a truncation length of stories or other content items in each module.

Any or all of multiple different display rules can be used. In some implementations, a numerical limit is applied. For example, the number of columns (and/or modules) that are visible in each viewport can be regulated. In some implementations, readability or other usability factors can be taken into account. For example, the maximal or minimal width of columns for optimized reading. In some implementations, a characteristic of content can be taken into account. For example, whether content elements in each column are distributed (e.g., as a list) or organized in a pile. In some implementations, a content importance characteristic is taken into account. For example, editorial content importance can be considered.

One or more content editor preferences can be taken into account. In some implementations, an editor can set preference(s) for off-screen content awareness to inform users that more content is available. For example, a viewport can indicate partially visible off-screen columns to suggest gesture panning to the column(s) into view. As another example, a column can include partially visible off-screen content item(s) to suggest gesture panning to bring the content into view.

Modular surface composition can be used. In some implementations, the layout is at least partially composed of modules, and the repertoire of the modules includes single-instance modules and replicated-pattern modules. All modules can have attributes that govern how they display their borders and interact with surrounding neighbor modules. For example, these attributes can be characterized as “urban planning” attributes. In some instances, content size and attributes can influence the position and size of a particular container (e.g., a column or an area within a column). Further proximity and/or adjacency to other content modules, as well as including within a particular area, can determine whether borders (i.e., “fences”) are visible and/or needed.

Examples of modular surface composition include, but are not limited to:

“shrink wrap,” such as by taking up the smallest possible area given internal content and minimum-width and -height rules;

“span out,” such as by taking up as much space as possible, by width and/or height, within the containing module or column;

“just right,” such as by using a module or content item size calculation that is content based, for example to provide optimal size for this content type, and/or to have minWidth and maxWidth specifications (e.g., in absolute content units, not as a percentage or other relative measurement);

calculating height and width of organizer modules based on content items inside that module, for example specified in item units (e.g., “five headlines”), which can allow for dynamic module boundaries and inclusion of whole content items without concealing item portions;

setting of module heights by an editor (e.g., to 7.3 cards”) so that items in proximity with boundaries are partially visible and suggest access to additional content with human interaction (e.g., a click, swipe or gaze); and

using content-smart truncation algorithms that respond to content-aware units (e.g., “five lines (of text)” or “two full sentences”).

Any or all different layout geometries can be included. In some implementations, horizontal and/or vertical columns can be used. The layout surfaces 100 (FIG. 1) and 200 (FIG. 2) are examples of this. Diagonal content bands can be used. For example, FIG. 3 shows an example of a layout surface 300 with diagonal content bands 302. Diagonal content bands can be considered “escalators.”

One or more concentric circles with rotating ring(s) of content can be used. For example, FIG. 4 shows an example of a layout surface 400 with concentrically circular content bands 402. Circular and/or arc shaped layouts can be used for quasi-navigation and for progressive disclosure of content details.

The above examples illustrate how a layout can be arranged in geometries. In some implementations, a diagonal set of diagonal columns (e.g., diagonal content bands 302) contain content items and can have interactive and automated motions, and/or can update independently of other diagonal columns. In the above examples, arrows indicate directions of content scrolling and/or content progression. For example, content can flow on its own, driven by infusion of additional content into that “stream,” or content path, based on changing content attributes, including, for example, new content, popular content, or more relevant content. The concentrically circular content bands 402 can rotate automatically or by request. In each band, content can be independent of other bands, or related thereto. For example, inner bands can correspond to topics and outer bands can contain content items for the topic(s). Content progression can be different than manual scrolling and/or gesture swiping, allowing a continuous, periodic, or event-driven continuation of content presentation (e.g., an automatic ticker, presentation of newer or additional content at the top of a list of content such that existing content is moved towards the back of the content presented, etc.).

One or more overlapping content lanes can flow over other content lanes and partially obscure the lane(s). For example, overlapping content lane 304 (FIG. 3) and/or overlapping content lane 404 (FIG. 4) can be used. In a sense, such lane(s) can be considered similar to a bicycle bridge passing over a motor highway. In some implementations, any other spatial arrangement of content bands on an endless surface, akin to how a multi-lane real-world road system appears and curves on a map, can be used.

Content can be layered in a layout. In some implementations, layered columns and modules can be positioned. This can provide a rich display of information. In some implementations, layered content is not intended for navigation, such as by using one-depth layering as a maximum. For example, a live content module can be provided over a live map. FIG. 5 shows an example of a layout surface 500 with a control element 502. In this example, the control element appears above content columns 504 that scroll and/or move independently below the control element.

Content browsing within a module can be provided. In some implementations, each module content can be browsed and viewed in manners unique to the specific content, and can be browsed in modes independent of other modules in the neighborhood. For example, a user can swipe a column up or down as a continuous content strip with a single axis of flow. As another example, a module can zoom into richer information (e.g., larger, and with more details.) As another example, a module can respond to content flipping without changing boundary size.

In some implementations, a simple module can display a single instance. For example, and without limitation, this can include a photo, an information card, a top story (e.g., a product information card.)

In some implementations, a module with replication has a single repeatable layout pattern that can be defined to smartly expand in one or more dimension. For example, this can occur when the layout responds to: increased content inflow or human content creation, changes in viewport or device, or changes in content zoom or focus.

In response to one or more layout change events, a replicated module can use rule(s) to add (or remove) columns to its current count, such as with set minimum and maximum numbers of columns. For example, “Top Stories” can correspond to minimum one column. If the viewport is in landscape position, a second column can be added. This feature may be referred to as “replication.” In other instances, many optimal-size columns in <WIDTH> pixels can be fitted. When
content count MOD specific <HEIGHT>
   is greater than seven items, a column can be added. The “MOD” mathematical operator means “integer division.” The “MOD” operator can be used to achieve container replication, allowing the system to determine how many time replication should occur, and exactly when it should take place. Only full containers are replicated based on the integer division. In addition, the user experience of adding new replicated containers is with smooth transitions. One example of replication follows: An interface may display an archive or library of documents or magazine with a visual depiction of shelves. As fresh material arrives at the archive, or when a user manually adds documents to the archive, additional shelves are automatically, and smoothly added. Such examples can illustrate contained content growths in a desired horizontal direction.

A content organizer with repetition can be used. In some implementations, content inside modules is arranged using one or more content organizers. The display of a flow of content items can be managed using repeatability rules. This can be done to manage the number of visible items using absolute rules and with opportunistic neighborhood rules. For example, up to five items can be displayed, and if the neighbor module below the current module is using less than its maximum item count, the current module can grow (i.e., beyond five items) in a desired direction (e.g., horizontally).

An organizer module with repetition can have one or more boundary sizes. In some implementations, a boundary size applies in addition to “shrink wrap” and/or “span out” attributes. Examples of boundary sizes include, but are not limited to: empty display size (e.g., no items), optimal display size, maximum display size, minimal display size (e.g., only a few items, fewer than maximum, are presented, and unused space is available to neighboring modules), a “more” size can be a larger-than-maximum size (or size-addition-increment) when a user explicitly requests to view more of the content, and a “show all” size may have unlimited size, without bounds, that includes all content in the organizer.

The following are examples of content organizer sizing rules. Several rules may be assigned, and some rules may have associated user interactions. Blog entries in a vertical column:
{Shrink Wrap, Empty, Minimal, Maximum, More}
   In this example, the module may have a visible depiction when empty of content, and may fluctuate between minimal and maximal display size based on content quantity. Further, it can enable users to access more content.

For news flashes in a vertical module, the following rules may be applied:
{Shrink Wrap, Empty, Optimal}
   This rule group above means that the size may fluctuate from empty to “optimal” size (e.g., do not show more than 5 headlines, units, or the specific item included in the container).

For an attachment organizer, the following rules may be applied:
{Shrink Wrap, Empty, Show All}
   The interpretation of this rule group is that size may fluctuate from empty to very long, as the rules allow the organizer to “Show All” items.

Organizer modules can include temporal rules and filters that govern which items to display and how many to display based on time considerations. For example:
A time dimension (such as latest, not older than, etc.)
A timed story release (e.g., a press release, or other content pieces that are pre-written with a precise publication time) can provide that content goes live starting on <DATE, TIME>.
A timed module appearance and reposition can provide that a layout rearranges itself with an event, or announcement module, appearing on <DATE, TIME>, or can move to special layout spots based on event-date proximity.
An effective date for pre-publishing, current publishing or sunset publishing can provide the ability to set “publish not before” and “unpublish after” dates for content items, and/or entire modules.
Retired, archived, fade and archive, or fade and disappear attributes can specify historical requirements for items, such as what to do with them after visibility expiration.

A module can be time traveled and the user can see layout motion and content motion over time (such as when using an adjacent time slider or a time slider in an overlay layer, for example, to “time-travel” across a history range of the surface.

Examples of organizer modules can include an endless content count. For example, a feed stream, news flash and/or an event log. Such a module can have endless flipping interactions (e.g., an endless deck of cards) and/or endless scrolling (e.g., when in a list.)

FIG. 6 shows an example of a tool 600 for generating a layout and/or a template. That is, in some implementations, the tool can be used to perform a flow for creating a template. For example, the tool can generate any or all of the layouts described in other examples herein. The tool includes a workspace area 602 where the user can generate one or more layouts or templates. A template area 604 is used for holding, presenting, or providing user selection of, one or more existing templates. A gallery area 606 makes available to the user one or more containers 608 that the user can employ to organize the workspace, and ultimately to create a new template. The container is used to contain the content from one or more particular content sources. In some implementations, one or more of the containers can be a widget designated for a particular type of content.

FIG. 7 shows an example of the tool 600 from FIG. 6. Here, an arrow 700 schematically illustrates that a user selects the container 608 in the gallery area 606 and places it in the workspace area 602. The template area is not shown, for clarity.

FIG. 8 shows an example of the tool 600 from FIG. 6. Here the user enlarges the container into an enlarged container 608′ in the workspace area 602.

FIG. 9 shows an example of the tool 600 from FIG. 6. Here, only the workspace area 602 is shown, for clarity. The user has expanded the enlarged container into a content container 608″, and has furthermore added and configured, in a similar fashion, a left container 900, a header container 902 and a footer container 904. The containers are organized in a pattern that is intended to become a new template in the tool.

FIG. 10 shows an example of the tool 600 from FIG. 6. In the template area 604, the user activates a save function 1000 for templates. That is, the function causes the layout/design as defined in the workspace area 602 to be documented and stored as a template.

FIG. 11 shows an example of the tool 600 from FIG. 6. An arrow 1100 from the workspace area 602 to the template area 604 schematically illustrates that a template 1102 is being created based on the workspace area.

FIG. 12 shows an example of the tool 600 from FIG. 6. The template 1102 in the template area 604 indicates that this newly created template is now available to the user for making one or more layouts or other designs.

FIG. 13 shows an example of the tool 600 from FIG. 6. An arrow 1300 from the template area 604 to the workspace area 602 schematically illustrates that the user can load the template 1102 to create a new layout or other design in the workspace area.

FIG. 14 shows an example of the tool 600 from FIG. 6. An arrow 1400 from the template 1102 in the template area 604 to the workspace area 602 schematically illustrates that the user can open a window 1402 for template rules. For example, this can be used for creating a template rules flow. That is, the window gives the user access to one or more rules that apply to the template as a whole. For example, a control 1404 indicates that the template can be provided with either a flexible size or a fixed size. The flexible-size option allows the template to resize itself based on some characteristic regarding its use, including, but not limited to, whether the template is displayed in a browser and what type the browser is, and/or the specific content that the template is being used with. If the fixed size option is selected, a control 1406 can allow the user to specify a particular width and/or height for the template. That is, in this situation the specified template size would not automatically adapt in use.

One or more other template rules can be specified in the window 1402. When the user saves the rule(s), the template is thereafter controlled according to the rule(s).

FIGS. 21 through 26 illustrated several examples rules and their execution. Additional and alternative rules may be applied, as these are merely illustrative examples. First, FIG. 21 illustrates an example rule providing an expandable or contractable widget. When provided with minimal space, the album (2105) includes an album description and a photo pile. When given additional space, however, the album can expand (2110) to include a description, several thumbnail pictures of several photos in the album, and a remaining photo pile. In some instances, the phone pile may be considered equivalent to a “more . . . ” link.

FIG. 22 illustrates a container that includes a list of widgets (here, stories) with non-visible borders. When given minimum width constraints (2205), only text associated with each story is provided. When the container grows, or is given additional space beyond the set threshold (2215), thumbnail figures associated with each story are added to the container (2210).

FIG. 23 illustrates an example replication rule in layout. In 2305, a container is inside a template minimum width. As the template expands (2310), the container obeys an “expand out” rule, continuing to expand the container. As the template continues to expand (2315), the container obeys a “max width” rule that overrides the “expand out” rule, such that the container stops expanding after reaching a particular size, even while the template continues its expansion.

In 2320, the template grows even further while passing a replication threshold 2322 (here, equal to a multiple of the minimum width of the container), and a new, second container is added. In 2325, both containers obey the “expand out” rule, allowing the containers to expand and grow at a similar rate. At 2330, when a second replication threshold 2332 (here, equal to triple the minimum width of the container) is reached, a third container is added to the template. This process can continue horizontally, vertically, or in any other suitable dimension or combination thereof. Further, in some instances, widgets inside the containers can also obey their content rules in real-time as additional space is available within the corresponding container.

FIG. 24 illustrates an example where different applied rule sets provide alternative operations. As illustrated in 2405, a first container including title elements is presented. When the container 2405 grows or is expanded within the template, the corresponding actions depend upon the rules set for the container and/or the template. In one instance (2410), the container may be assigned a rule to “add more widgets” when expanded. Thus, the illustration (2410) shows additional titles presented in the expanded container. Alternatively, the container may be assigned a rule to “distribute height” when expanded. As shown in 2415, each of the original titles are equally expanded with additional text. In a third example, the container may be assigned combined rules to both “add more widgets” and “allow widgets to grow.” As illustrated in 2420, the titles are included with text in an equal distribution, and a new title is added to the container.

FIG. 25 illustrates containers and templates where ranking and timing rules are assigned. In 2505, event widget (content) 2507 is presented in a secondary location (i.e., not the top) since the event is six (6) weeks prior to its occurrence. Based on a combination of social traffic and timing rules, event widget 2507 can be repositioned and presented in the primary location of the layout (2510) as social traffic associated with the event widget 2507 increases, and as the time to the event becomes closer. Additionally, the event widget 2507 is expanded in size, with additional content available and presented within the widget 2507. The next illustration (2515) shows the event widget 2507 just before or during the event with updated content. Upon completion or ending of the event, the event widget 2507 can both (1) change content to reflect its completion and (2) be repositioned to a secondary location.

In some instances, methods for assigning rules to widgets, containers, and template parts can be implemented and applied “in situ” onto each of the objects. FIG. 26 provides such an example and several rule assignment possibilities. In the example, a widget or container may “light up,” or present/identify potential options for applying rules. As illustrated in FIG. 26, handles associated with each of option sets 2610, 2615, and 2620 can be highlighted when the focus of, for example, a user's pointer is moved close to the container 2605. Each rule handle, when selected or focused upon, can open a smart rule box for assigning rules (e.g., box 2610, 2615, and 2620). The existence of rule handles can indicate to users that a widget or container is capable of being assigned and obeying rules. As illustrated by 2610, an “expand out” or “shrink wrap” rule may be assigned, while 2615 provides rules associated with when the container 2605 is expanded, particularly a “replicate containers” rule. Further, 2620 provides rules for when the container 2605 is made taller, allowing users to select to “add widgets” or “grow widgets.” Numerous other rules may be available and/or applied in alternative examples and implementations. In some instances, a widget or container may serve as a representative to a collection of widgets or containers when the “replicate” rule is assigned.

FIG. 15 shows an example of the tool 600 from FIG. 6. In some implementations, the tool can be used for creating rules for the entire template, such as by defining a rule for the header template part. The template part rules can override template rules. A template part can contain one or more containers (e.g., a widget) and the rule(s) will be applied to all of them.

Here, an arrow 1500 from the header container 902 schematically illustrates that the user can open a window 1502 for header rules. That is, this window gives the user access to one or more rules that apply to the header container. For example, a control 1504 allows the user to specify whether the header container should be rankable, have a fixed size, have a specific time to live, should be archived, or be adjustable to screen resolution. For some of the selectable rules, the user can, if necessary, specify one or more applicable data, such as a date and/or time until which the header is archived. If a widget is rankable, then one or several ranking rules may apply. For example, a social interest ranking may be applied, where the rule is based in part on a number of page views, reads, or likes. Another rule may be a scientific citations ranking based on the number of scientists or engineers that have cited a particular article—the more read and cited the article the higher in relevance, and thus, the article or content may be repositioned, resized, and or emphasized, among others. Another example rule may be based on legal ranking, where that legal ranking is based on the number of views, downloads, or citations of a particular article or content, including legal citations in formally filed documents or databases, as well as how recent the latest citation is. When a widget is higher in rank, it may possess several characteristics based on how high the relative ranking, such as a larger title, a larger content area, additional content (e.g., a photo or excerpt), more prominent positioning within a column or overall template, and whether to include or associate advertisements, promotions, or other sponsored content with the ranked content.

FIG. 16 shows an example of the tool 600 from FIG. 6. In some implementations, the tool can be used for creating one or more rules for a container (e.g., a widget). For example, the widget rule(s) can override the template rule(s) and the template part rule(s). That is, the rules can be considered to form the following hierarchy:
Container rule
Template part rule
Template rule

where a higher rule takes precedence over a lower rule, where applicable. For example, if the template rule specifies a certain maximum template width but wherein a template part rule creates a need for more width than specified, the template rule will be ignored or set aside in this regard. Likewise, if the template part rule specifies some characteristic that cannot be satisfied based on a rule defined for a container located in that template part, the template part rule will be ignored, or adjusted, as necessary.

In some implementations, a hierarchy of layout and content rules may exist. The rule hierarchy can be content driven (e.g., from the bottom up) as well as layout driven (e.g., from the top down). In one example, template T1 has a width rule of 300 pixels for a vertical container (i.e., a column). The container C1 has a rule that all widgets in the container have a rank greater than 4, and a maximum widget height of 200 pixels. Each widget (W1, W2, W3, . . . ) may also have size and content rules. Widget W1 has a minimum height rule of one (1) full paragraph plus a photo. Based on the determined hierarchy, widget W1 may override container C1's rule regarding the maximum widget height when the widget includes a full paragraph of greater than 200 pixels. Additional and alternative hierarchies may be defined so that templates, containers, and widgets can be combined where some of the components rules are not literally compatible.

In FIG. 16, an arrow 1600 from the gallery area 606 to the workspace area 602 indicates that the user selects a widget 1602 and places it in the layout, in this example in the content container 608″. An arrow 1604 from the widget 1602 schematically illustrates that the user can open a window 1606 for widget rules. That is, this window gives the user access to one or more rules that apply to the widget. For example, the user can specify whether the widget should be rankable, have a fixed size, have a specific time to live, should be archived, or be adjustable to screen resolution.

FIG. 17 shows an example of the tool 600 from FIG. 6. Here, an arrow 1700 indicates that the user selects widgets 1702 and 1704 in the gallery area and places them in the left container 900. Arrows 1706 indicate that the widgets adjust themselves according to their rule(s), and according to the rule(s) of the container and the template. Placing a widget inside a container may only be a starting point for the “life” of that widget. Additional rules for both the widget and the container may move the widget up or down within the container, add or subtract content including within the widget, modify the size of the widget, and/or relocate the widget to a more prominent location.

FIG. 18 shows an example of the tool 600 from FIG. 6. An arrow 1800 indicates that the user changes the template width.

FIG. 19 shows an example of the tool 600 from FIG. 6. The left container has now expanded into an enlarged left container 900′ based on the change of template width described above. Consequently, the content container is reduced into a diminished content container 608′″. Arrows 1900 indicate that the widgets adjust their size accordingly, to form adjusted widgets 1702′ and 1704′.

FIG. 20 is a schematic diagram of a generic computer system 2000. The system 2000 can be used for the operations described in association with any of the computer-implement methods described previously, according to one implementation. The generic computer system 2000 may represent any type of suitable computing system, including a mobile computing device (e.g., a smartphone, tablet computer, etc.), where smart layouts are provided for display on varying size screens. The system 2000 includes a processor 2010, a memory 2020, a storage device 2030, and an input/output device 2040. Each of the components 2010, 2020, 2030, and 2040 are interconnected using a system bus 2050. The processor 2010 is capable of processing instructions for execution within the system 2000. In one implementation, the processor 2010 is a single-threaded processor. In another implementation, the processor 2010 is a multi-threaded processor. The processor 2010 is capable of processing instructions stored in the memory 2020 or on the storage device 2030 to display graphical information for a user interface on the input/output device 2040.

The memory 2020 stores information within the system 2000. In some implementations, the memory 2020 is a computer-readable medium. The memory 2020 is a volatile memory unit in some implementations and is a non-volatile memory unit in other implementations.

The storage device 2030 is capable of providing mass storage for the system 2000. In one implementation, the storage device 2030 is a computer-readable medium. In various different implementations, the storage device 2030 may be a floppy disk device, a hard disk device, an optical disk device, or a tape device.

The input/output device 2040 provides input/output operations for the system 2000. In one implementation, the input/output device 2040 includes a keyboard and/or pointing device. In another implementation, the input/output device 2040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. For example, any suitable type of media may be incorporated into the solution. For a device capable of audio, or that displays mostly visual images, the system can serve the appropriate content based on the content rules and ranking rules. Accordingly, other implementations are within the scope of the following claims.

What is claimed is:

1. A computer-implemented method for generating a content-driven layout, the method comprising:
receiving a first user input specifying a template rule for a template being generated;
receiving a second user input specifying a template part rule for a part of the template, wherein the template part rule takes precedence over the template rule;
receiving a third user input specifying a container rule for a container located in the part of the template, wherein the container rule takes precedence over the template part rule and the template rule;
applying, based on content provided for the template, at least one of the template rule, template part rule and the container rule based on the precedence; and
presenting the template including the provided content, based on applying the at least one rule to the template.

2. The computer-implemented method of claim 1, further comprising:
determining that a rule hierarchy exists between at least two of the container rule, template part rule, and template rule; and
applying at least one of the container rule, template part rule, and template rule to resolve conflicting of the rules based on the rule hierarchy determination.

3. The computer-implemented method of claim 1, further comprising receiving, after presenting the template, new or modified content for the template, and adjusting the template based on the received content.

4. The computer-implemented method of claim 1, further comprising generating a graphical user interface that includes a workspace area, a template area and a gallery area, wherein the user generates the template by placing at least one container from the gallery area into the workspace area.

5. The computer-implemented method of claim 1, wherein the template includes diagonal content bands.

6. The computer-implemented method of claim 1, wherein the template includes concentrically circular content bands.

7. The computer-implemented of claim 1, wherein the template includes horizontal and vertical content bands, wherein at least one of the horizontal or vertical content bands include at least one embedded level of additional content bands.

8. The computer-implemented method of claim 1, wherein the template includes a control element that appears above content columns, and wherein the content columns scroll or move independently below the control element.

9. A computer program product embodied in a non-transitory computer-readable storage medium and comprising instructions that when executed by a processor perform a method for generating a content-driven layout, the method comprising:
receiving a first user input specifying a template rule for a template being generated;
receiving a second user input specifying a template part rule for a part of the template, wherein the template part rule takes precedence over the template rule;
receiving a third user input specifying a container rule for a container located in the part of the template, wherein the container rule takes precedence over the template part rule and the template rule;
applying, based on content provided for the template, at least one of the template rule, template part rule and the container rule based on the precedence; and
presenting the template including the provided content, based on applying the at least one rule to the template.

10. The computer program product of claim 9, the method further comprising:
determining that a rule hierarchy exists between at least two of the container rule, template part rule, and template rule; and
applying at least one of the container rule, template part rule, and template rule to resolve conflicting of the rules based on the rule hierarchy determination.

11. The computer program product of claim 9, the method further comprising receiving, after presenting the template, new or modified content for the template, and adjusting the template based on the received content.

12. The computer program product of claim 9, the method further comprising generating a graphical user interface that includes a workspace area, a template area and a gallery area, wherein the user generates the template by placing at least one container from the gallery area into the workspace area.

13. The computer program product of claim 9, wherein the template includes diagonal content bands.

14. The computer program product of claim 9, wherein the template includes concentrically circular content bands.

15. The computer program product of claim 9, wherein the template includes a control element that appears above content columns, and wherein the content columns scroll or move independently below the control element.

16. A system comprising:
one or more processors; and
a computer program product embodied in a non-transitory computer-readable storage medium and comprising instructions that when executed by a processor perform a method for generating a content-driven layout, the method comprising:
receiving a first user input specifying a template rule for a template being generated;
receiving a second user input specifying a template part rule for a part of the template, wherein the template part rule takes precedence over the template rule;
receiving a third user input specifying a container rule for a container located in the part of the template, wherein the container rule takes precedence over the template part rule and the template rule;
applying, based on content provided for the template, at least one of the template rule, template part rule and the container rule based on the precedence; and
presenting the template including the provided content, based on applying the at least one rule to the template.

17. The system of claim 16, the method further comprising:
determining that a rule hierarchy exists between at least two of the container rule, template part rule, and template rule; and
applying at least one of the container rule, template part rule, and template rule to resolve conflicting of the rules based on the rule hierarchy determination.

18. The system of claim 16, the method further comprising receiving, after presenting the template, new or modified content for the template, and adjusting the template based on the received content.

19. The system of claim 16, the method further comprising generating a graphical user interface that includes a workspace area, a template area and a gallery area, wherein the user generates the template by placing at least one container from the gallery area into the workspace area.

20. The system of claim 16, wherein the template includes a control element that appears above content columns, and wherein the content columns scroll or move independently below the control element.
